(19) United States
(12) Patent Application Publication
(10) Pub. No.: US 2025/0016552 A1
(43) Pub. Date: Jan. 9, 2025

(54) Conveying Data to a Communication Network

(71) Applicant: Telefonaktiebolaget LM Ericsson (publ), Stockholm (SE)

(72) Inventors: Jaime Jiménez, Espoo (FI); Patrik Salmela, Espoo (FI)

(21) Appl. No.: 18/697,588

(22) PCT Filed: Oct. 4, 2021
(86) PCT No.: PCT/EP2021/077241

§ 371 Date: Apr. 1, 2024

(51) Int. Cl. H04W 12/02; H04W 12/03; H04W 12/72

(52) U.S. Cl. CPC H04W 12/02; H04W 12/03; H04W 12/72

(57) ABSTRACT

A communication device is configured for use in a communication network (10). The communication device generates a subscription concealed identifier (20) that conceals a subscription identifier part (16A) of a subscription permanent identifier (16) and conceals a set (22) of one or more data fields which is agnostic as to a type of data that the set (22) conveys. The communication device transmits the subscription concealed identifier (20). Based on the conveyed data, a network node may configure the communication network (10) for use by the subscription.

### TECHNICAL FIELD

The present application relates generally to a communication network, and relates more particularly to conveying data to such a network.

### BACKGROUND

The 5^{th} Generation of communication networks caters to expanded use cases, including not only mobile broadband and Internet of Things (IoT) but also industrial IoT, Ultra-Reliable Low-Latency Communications (URLLC), extended Reality (XR), cloud gaming, autonomous driving, and more. Network slicing enables a communication network to partition the network to accommodate these different use cases on top of a common network infrastructure, e.g., so as to optimize different network slices for different use cases. In fact, network slicing may be dynamic in nature, whereby the network can orchestrate and deploy a network slice on demand. As the types of services and/or communication requirements become more varied and even change dynamically, challenges exist in how to convey data from a subscriber to the network, especially in a secure and/or future-proof way, so that the network can tailor its resources and/or services to meet the needs of a subscriber at any given time.

### SUMMARY

Some embodiments herein exploit a subscription concealed identifier (SUCI) for flexibly conveying any type of data to a communication network. These and other embodiments may thereby leverage the SUCI as a data-type agnostic channel via which to convey data to the network. The data-type agnostic manner by which the data is conveyed via the SUCI preserves flexibility for varied and/or changing uses, e.g., so that the SUCI can remain a stable way to convey data even as the type(s) of data needing to be conveyed changes over time with evolving communication networks. Moreover, in some embodiments, the data that is conveyed in a data-type agnostic manner is concealed in the SUCI so as to secure the data against eavesdropping and/or make the data transparent to a visited network.

More particularly, in some embodiments, a SUCI includes a set of data field(s) that is flexibly usable to convey any type of data. The set of data field(s) thereby conveys data but is agnostic as to the type of data that the set conveys. The set of data field(s) may include, for example, a value field that conveys the data and a type field that indicates a type of the data, e.g., to inform the recipient about how to parse the value field. In these and other embodiments, then, the set of data field(s) is not specific to or dedicated for always conveying any one type of data, but rather is extendable to conveying any type of data.

With a SUCI usable to convey data in a data-type agnostic manner, the SUCI in some embodiments is particularly usable for conveying any data associated with the subscription. For example, the SUCI may be usable for conveying data that describes communication, service, and/or network resources associated with the subscription, e.g., on a dynamic basis. Such data may for instance include any of: (i) data that describes a type and/or pattern of communication expected for the subscription; (ii) a requirement and/or policy to be met for communication associated with the subscription; or (iii) a network slice and/or mobile virtual network operator associated with the subscription. Using the SUCI to convey these or other types of data associated with a subscription may prove particularly helpful for equipping the network, in a secure and/or future-proof way, with data usable to tailor the network's resources and/or services to meet the needs of the subscriber at any given time. For example, the data conveyed via the SUCI may be usable for dynamic network slicing, e.g., whereby the network may dynamically orchestrate and deploy a network slice for the subscriber on demand, as needed to accommodate the subscriber's expected communication pattern and/or quality of service requirements.

More particularly, embodiments herein include a method performed by a communication device configured for use in a communication network. The method comprises generating a subscription concealed identifier that conceals a subscription identifier part of a subscription permanent identifier and conceals a set of one or more data fields which is agnostic as to a type of data that the set conveys, and transmitting the subscription concealed identifier.

In some embodiments, the set of one or more data fields include a value field and a type field. In this case, the value field conveys the data and the type field indicates a type of the data conveyed. Additionally or alternatively, the set of one or more data fields include a value field, a length field, and a type field. In this case, the value field conveys the data, the type field indicates a type of the data conveyed, and the length field indicates a length of the value field or a length of the set of one or more fields.

In some embodiments, the set of one or more data fields conveys data describing communication, service, and/or network resources associated with a subscription identified by the subscription permanent identifier. In one or more of these embodiments, the data describes a type and/or pattern of communication expected for the subscription, and/or a mobility pattern expected for the subscription, and/or a requirement and/or policy to be met for communication associated with the subscription. In one or more of these embodiments, the data indicates a Manufacturer Usage Description, MUD, file associated with the subscription. In one or more of these embodiments, the data indicates a network token associated with the subscription. In one or more of these embodiments, the network resources associated with the subscription include a network slice and/or a mobile virtual network operator associated with the subscription.

In some embodiments, generating a subscription concealed identifier comprises constructing a scheme input from the subscription identifier part and from the set of one or more data fields, executing a protection scheme with the constructed scheme input as input, to obtain a scheme output, and constructing the subscription concealed identifier with a data field that contains the scheme output.

In some embodiments, transmitting the subscription concealed identifier comprises transmitting the subscription concealed identifier in a registration request or a service request to the communication network.

In some embodiments, the subscription concealed identifier is a SUbscription Concealed Identifier, SUCI, and the subscription permanent identifier is a SUbscription Permanent Identifier, SUPI.

Other embodiments herein include a method performed by a network node configured for use in a communication network. The method comprises receiving a subscription concealed identifier that conceals a subscription identifier part of a subscription permanent identifier and conceals a set of one or more data fields which is agnostic as to a type of data that the set conveys.

In some embodiments, the set of one or more data fields include a value field and a type field. In this case, the value field conveys the data and the type field indicates a type of the data conveyed. Additionally or alternatively, the set of one or more data fields include a value field, a length field, and a type field. In this case, the value field conveys the data, the type field indicates a type of the data conveyed, and the length field indicates a length of the value field or a length of the set of one or more fields.

In some embodiments, the set of one or more data fields conveys data describing communication, service, and/or network resources associated with a subscription identified by the subscription permanent identifier. In one or more of these embodiments, the data describes a type and/or pattern of communication expected for the subscription, and/or a mobility pattern expected for the subscription, and/or a requirement and/or policy to be met for communication associated with the subscription. In one or more of these embodiments, the data indicates a Manufacturer Usage Description, MUD, file associated with the subscription. In one or more of these embodiments, the data indicates a network token associated with the subscription. In one or more of these embodiments, the network resources associated with the subscription include a network slice. Additionally or alternatively, the network resources associated with the subscription include a mobile virtual network operator associated with the subscription.

In one or more embodiments, the method further comprises, based on the conveyed data, configuring the communication network for use by the subscription. In one or more of these embodiments, configuring the communication network comprises one or more of allocating resources in the communication network for use by the subscription, selecting and/or configuring network services for the subscription, orchestrating, selecting, and/or configuring a network slice for use by the subscription, configuring an access network for the subscription, configuring a session for the subscription, or allocating an address for use by the subscription. In one or more of these embodiments, configuring the communication network comprises orchestrating, based on the data conveyed by the set, a network slice, for use by the subscription, that matches a type and/or pattern of communication expected for the subscription and/or that meets a requirement and/or policy to be met for communication associated with the subscription.

In some embodiments, receiving a subscription concealed identifier comprises receiving the subscription concealed identifier in a registration request or a service request from a communication device.

In some embodiments, the subscription concealed identifier is a SUbscription Concealed Identifier, SUCI, and the subscription permanent identifier is a SUbscription Permanent Identifier, SUPI.

In some embodiments, the method further comprises de-concealing the subscription identifier part and/or the set of one or more data fields, and transmitting at least the de-concealed subscription identifier part and/or the set of one or more data fields to another network node in the communication network.

Other embodiments herein include a communication device configured for use in a communication network communication circuitry and processing circuitry. The processing circuitry is configured to generate a subscription concealed identifier that conceals a subscription identifier part of a subscription permanent identifier and conceals a set of one or more data fields which is agnostic as to a type of data that the set conveys, and transmit the subscription concealed identifier.

In some embodiments, the processing circuitry is configured to perform the steps described above for a communication device.

Other embodiments herein include a network node configured for use in a communication network. The network node comprises communication circuitry and processing circuitry. The processing circuitry is configured to receiving a subscription concealed identifier that conceals a subscription identifier part of a subscription permanent identifier and conceals a set of one or more data fields which is agnostic as to a type of data that the set conveys.

In some embodiments, the processing circuitry is configured to perform the steps described above for a network node.

Other embodiments herein include a computer program comprising instructions which, when executed by at least one processor of a communication device, causes the communication device to perform the steps described above for a communication device. Other embodiments herein include a computer program comprising instructions which, when executed by at least one processor of a network node, causes the network node to perform the steps described above for a network node. In one or more of these embodiments a carrier containing the computer program described above is one of an electronic signal, optical signal, radio signal, or computer readable storage medium.

### BRIEF DESCRIPTION OF THE DRAWINGS

FIG. 1 is a block diagram of a communication network according to some embodiments.

FIG. 2 is a block diagram of a subscription concealed identifier according to some embodiments.

FIG. 3A is a block diagram of a subscription concealed identifier formed from an IMSI according to some embodiments.

FIG. 3B is a block diagram of a subscription concealed identifier formed from an NAI according to some embodiments.

FIG. 4 is a call flow diagram of conveying data from a UE to a 5G network via a SUCI according to some embodiments.

FIG. 5 is a logic flow diagram of a method performed by a communication device according to some embodiments.

FIG. 6A is a logic flow diagram of a method performed by a network node according to some embodiments.

FIG. 6B is a logic flow diagram of a method performed by a network node according to some embodiments.

FIG. 7 is a block diagram of a communication device according to some embodiments.

FIG. 8 is a block diagram of a network node according to some embodiments.

FIG. 9 is a block diagram of a communication system in accordance with some embodiments.

FIG. 10 is a block diagram of a user equipment according to some embodiments.

FIG. 11 is a block diagram of a network node according to some embodiments.

FIG. 12 is a block diagram of a host according to some embodiments.

FIG. 13 is a block diagram of a virtualization environment according to some embodiments.

FIG. 14 is a block diagram of a host communicating via a network node with a UE over a partially wireless connection in accordance with some embodiments.

### DETAILED DESCRIPTION

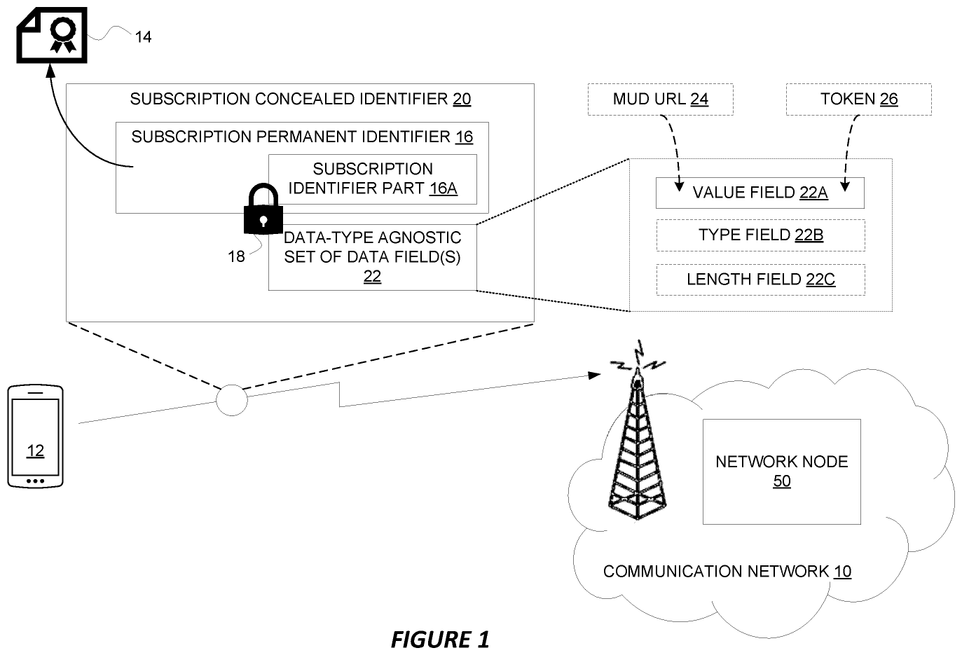

FIG. 1 shows a communication network 10 according to some embodiments, e.g., in the form of a 5G network. The communication network 10 is configured to provide communication service to a communication device 12. In some embodiments, the communication network 10 is a wireless communication network, in which case the communication device 12 may be a wireless communication device. Regardless, the communication network 10 is configured to provide communication service to the communication device 12 on the basis of a subscription 14 to receive such service from the communication network 10. The communication device 12 accordingly transmits signaling to the communication network 10 identifying the subscription 14, e.g., as part of a procedure for registering with and/or requesting service from the communication network 10.

As shown, for example, the communication device 12 signals a subscription permanent identifier 16 identifying the subscription 14. The subscription permanent identifier 16 may for example be a SUbscription Permanent Identifier (SUPI) as specified by the 3^{rd} Generation Partnership Project (3GPP), e.g., in 3GPP Technical Specification (TS) 23.501 v17.1.1. Regardless, the subscription permanent identifier (SUPI) 16 identifies the subscription 14 over a long term, so as to persist across different sessions of the communication service, e.g., as may be needed for charging the subscriber for the service. In some embodiments, for example, the subscription permanent identifier 16 takes the form of an International Mobile Subscriber Identity (IMSI) or a Network Access Identifier (NAI) (username@realm).

To preserve subscriber privacy, though, the communication device 12 conceals at least a part of the subscription permanent identifier 16 before signaling it. In particular, the communication device 12 conceals at least a subscription identifier part 16A that specifically identifies the subscription 14 from among subscriptions to the communication network 10. For example, in embodiments where the subscription permanent identifier 16 includes a network identifier part (not shown) that identifies the communication network 10 and the subscription identifier part 16A that identifies the subscription 14, the communication device 12 may conceal the subscription identifier part 16A but not the network identifier part. Concealing the subscription identifier part 16A may involve executing a protection scheme 18 with the subscription identifier part 16A, where that protection scheme 18 encrypts the subscription identifier part 16A so as to conceal it. The subscription identifier part 16A may for instance be encrypted using a public key of the communication network 10, such that only the communication network 10 can decrypt the subscription identifier part 16A using the network's private key. Regardless, concealing at least the subscription identifier part 16A of the subscription permanent identifier 16 produces a so-called subscription concealed identifier (SUCI) 20 that contains the subscription permanent identifier 16 as at least partly concealed. The subscription concealed identifier 20 may for example be a SUbscription Concealed Identifier (SUCI) as specified by the 3^{rd} Generation Partnership Project (3GPP), e.g., in 3GPP Technical Specification (TS) 23.501 v17.1.1. In any event, it is this subscription concealed identifier 20 that the communication device 12 transmits to the communication network 10.

Some embodiments herein exploit the subscription concealed identifier 20 for flexibly conveying any type of data to the communication network 10. These and other embodiments may thereby leverage the subscription concealed identifier 20 as a data-type agnostic channel via which to convey data to the network 10. In other words, some embodiments piggyback data on the subscription concealed identifier 20 in a data-type agnostic way. The data-type agnostic manner by which the data is conveyed via the subscription concealed identifier 20 preserves flexibility for varied and/or changing uses, e.g., so that the subscription concealed identifier 20 can remain a stable way to convey data even as the type(s) of data needing to be conveyed changes over time with evolving communication networks or services.

FIG. 1 for example shows that, in some embodiments, the subscription concealed identifier 20 includes a data-type agnostic set 22 of one or more data fields. This data-type agnostic set 22 of data field(s) is a set of data field(s) that conveys data in a way which is agnostic as to the type of data that the set 22 conveys. The data-type agnostic set 22 of data field(s) is thereby flexibly usable to convey any type of data. Accordingly, the set 22 of data field(s) is not specific to or dedicated for always conveying any one type of data, but rather is extendable to conveying any type of data.

As one example shown in FIG. 1, the data-type agnostic set 22 of data field(s) may include a value field 22A that conveys the data. According to embodiments herein, this value field 22A may convey any type of data so as to be data-type agnostic. The value field 22A is not specific to or dedicated for conveying any one type of data. To assist the recipient with parsing the value field 22A, the data-type agnostic set 22 of data field(s) in some embodiments also includes a type field 22B that indicates a type of the data. This way, the communication device 12 may populate the value field 22A with any type of data and then use the type field 22B to dynamically signal which type of data is conveyed by the value field 22A. The data-type agnostic set 22 of data field(s) in this case may include a type-value pair, also referred to as a key-value pair, field-value pair, name-value pair, or attribute-value pair. In other embodiments, the data-type agnostic set 22 of data field(s) further includes a length field 22C, e.g., so as to include a type-length-value (TLV) tuple. The length field 22C may indicates a length of the value field 22A or a length of the set 22 as a whole.

Note, though, that in some embodiments the data-type agnostic 22 of data field(s) may convey multiple types of data. In one embodiment, for instance, the data-type agnostic set 22 of data field(s) includes multiple value fields 22A that convey respective types of data, e.g., where each value field 22A may convey any type of data so as to be data-type agnostic. The data-type agnostic set 22 of data field(s) may also include multiple type fields 22B for indicating the type of data conveyed by respective ones of the value fields 22A. This way, the communication device 12 may populate each value field 22A with any type of data and then use the respective type field 22B to dynamically signal which type of data is conveyed by that value field 22A. The data-type agnostic set 22 of data field(s) in this case may include multiple type-value pairs, also referred to as key-value pairs, field-value pairs, name-value pairs, or attribute-value pairs. In other embodiments, the data-type agnostic set 22 of data field(s) further includes multiple length fields 22C, e.g., so as to include multiple type-length-value (TLV) tuple.

No matter the particular form of the data-type agnostic set 22 of data field(s), the communication device 12 in some embodiments conceals the data-type agnostic set 22 of data field(s) in the subscription concealed identifier 20. Concealing the data-type agnostic set 22 of data field(s) in this way may advantageously secure the data against eavesdropping on the air interface and/or make the data transparent to a visited network to which the communication device 12 may roam. Transparency of the data to the visited network may facilitate backwards compatibility of the subscription concealed identifier 20 from the perspective of the visited network, despite the inclusion of the data-type agnostic set 22 of data field(s), since the visited network does not process or need to understand the concealed part of the subscription concealed identifier 20. This means that the inclusion of the data-type agnostic set 22 of data field(s) need not be standardized or understood by roaming partners of a communication network operator. If the conveyed data is useful to a visited network, the communication network 10 may nonetheless extract the data from the subscription concealed identifier 20 and signal the data to the visited network in some other way, e.g., using traditional inter-network configuration signaling after the network 10 has translated the data to commands or requests understood by the visited network.

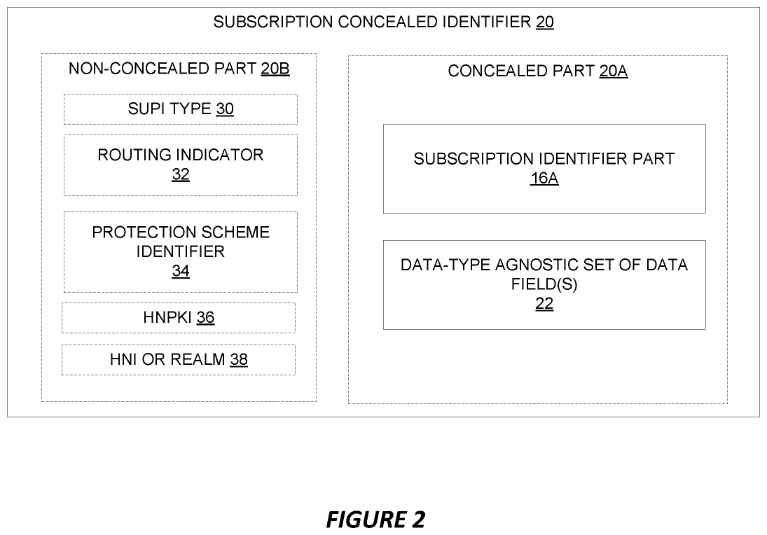

FIG. 2 illustrates additional details of some embodiments for concealing the data-type agnostic set 22 of data field(s) in the subscription concealed identifier 20. As shown, the subscription concealed identifier 20 includes at least a concealed part 20A. The concealed part 20A is a part of the subscription concealed identifier 20 that is concealed. The concealed part 20A in this case correspondingly includes at least the subscription identifier part 16A identifying the subscription 14 and the data-type agnostic set 22 of data fields. In one or more embodiments, the subscription concealed identifier 20 also includes an non-concealed part 20B that is not concealed. The non-concealed part 20B as shown may include a SUPI type field 30 that identifies the type of the subscription permanent identifier 16 concealed in the subscription concealed identifier 20; (ii) a routing indicator (RI) field 32 for routing the subscription concealed identifier 20 to the appropriate authentication server; (iii) a protection scheme identifier field 34 for identifying the protection scheme used to conceal the subscription concealed identifier 20; and/or (iv) a home network public key identifier (HNPKI) field 36 that identifies a key provisioned by the subscriber's home network for protecting the subscription concealed identifier 20. The non-concealed part 20B may further includes a home network identifier (HNI) or realm field 38 that identifies the communication network 10 to which the subscription 14 relates, e.g., where the field 38 may convey a HNI if the subscription permanent identifier 16 is an IMSI and convey a realm if the subscription permanent identifier 16 is an NAI.

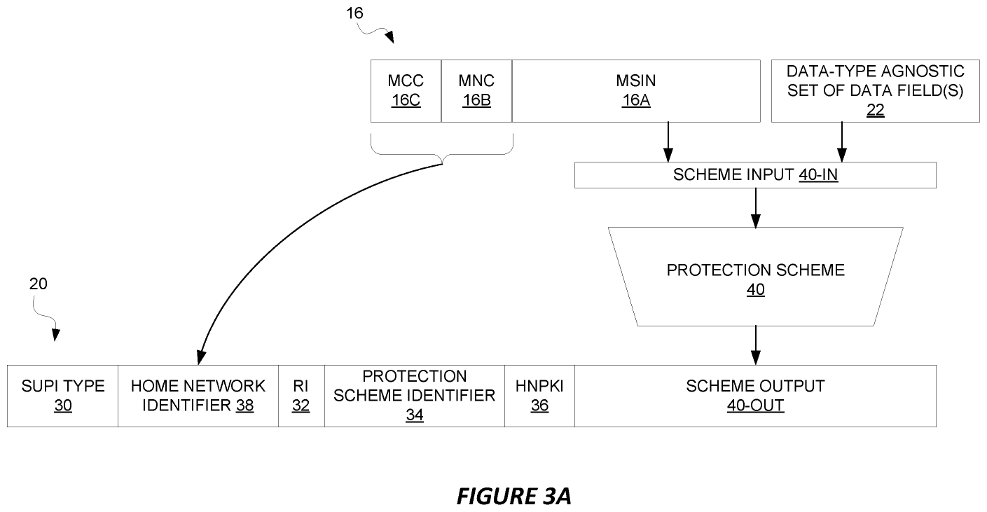

FIG. 3A shows one example where the subscription permanent identifier 16 is an IMSI. As shown, the subscription permanent identifier 16 in this case includes the subscription identifier part 16A in the form of a Mobile Subscriber Identification Number (MSIN) that identifies the subscription 14 from among all of the subscriptions to the communication network 10. The subscription permanent identifier 16 further includes a Mobile Network Code (MNC) 16B and a Mobile Country Code (MCC) 16C that collectively identifies the communication network 10 to which the MSIN relates, e.g., where the MCC indicates the country in which the subscription 14 is located and the MNC identifies the network operator within that country. The communication device 12 in this case constructs the subscription concealed identifier 20 from the SUPI type field 30, the RI field 32, the protection scheme identifier field 34, the HNPKI field 36, and a home network identifier field 38. The communication device 12 as shown sets the home network identifier field 38 to the MCC 16C and the MNC 16B of the subscription permanent identifier 16. The communication device 12 in these embodiments does not conceal the SUPI type field 30, the RI field 32, the protection scheme identifier field 34, the HNPKI field 36, or the home network identifier field 38.

As further shown in FIG. 3A, the communication device 12 constructs a scheme input 40-IN from the subscription identifier part 16A (i.e., the MSIN) and the data-type agnostic set 22 of data field(s). The communication device 12 then executes a protection scheme 40 with the constructed scheme input 40-IN as input and takes a scheme output 40-OUT as output. It is this scheme output 40 from which the subscription concealed identifier 20 is constructed, e.g., as opposed to the MSIN itself and/or the data-type agnostic set 22 of data field(s) in plain text. Constructed in this way, then, the subscription concealed identifier 20 conceals both the MSIN and the data-type agnostic set 22 of data field(s).

FIG. 3B by contrast shows one example where the subscription permanent identifier 16 is an NAI. As shown, the subscription permanent identifier 16 in this case includes the subscription identifier part 16A in the form of a username that identifies the subscription 14 from among all of the subscriptions to the communication network 10. The subscription permanent identifier 16 further includes a realm 16B that identifies the communication network 10 to which the username relates. The communication device 12 in this case constructs the subscription concealed identifier 20 from the SUPI type field 30, the RI field 32, the protection scheme identifier field 34, the HNPKI field 36, and a realm field 38. The communication device 12 as shown sets the realm field 38 of the subscription concealed identifier 20 to the realm 16B of the subscription permanent identifier 16. The communication device 12 in these embodiments does not conceal the SUPI type field 30, the RI field 32, the protection scheme identifier field 34, the HNPKI field 36, or the realm field 38.

As further shown in FIG. 3B, the communication device 12 constructs a scheme input 40-IN from the subscription identifier part 16A (i.e., the username) and the data-type agnostic set 22 of data field(s). The communication device 12 then executes a protection scheme 40 with the constructed scheme input 40-IN as input and takes a scheme output 40-OUT as output. It is this scheme output 40 from which the subscription concealed identifier 20 is constructed, e.g., as opposed to the username itself and/or the data-type agnostic set 22 of data field(s) in plain text. Constructed in this way, then, the subscription concealed identifier 20 conceals both the username and the data-type agnostic set 22 of data field(s).

In some embodiments, concealing the data-type agnostic set 22 of data field(s) subjects the data conveyed by the set 22 to size or length requirements. In some embodiments, for instance, the data may be subject to a requirement that the combined length of the data-type agnostic set 22 of data field(s) and the subscription identifier part 16, after concealment, be no more than 3000 octets plus the length of the input. That is, the length of the scheme output 40-OUT in this case must be less than or equal to 3000 octets plus the length of the scheme input 40-IN. In this context, some embodiments herein are usable for conveying any type of data within these length requirements.

In other embodiments, though, the data-type agnostic set 22 of data field(s) may be included in the non-concealed part 30B of the subscription concealed identifier 20. This may be advantageous for enabling a visited network to exploit the data-type agnostic set 22 of data field(s).

No matter whether and/or how the data-type agnostic set 22 of data field(s) is concealed in the subscription concealed identifier 20, by conveying the data via the subscription concealed identifier 20, some embodiments herein are able to accommodate different authentication mechanisms being used for access to the communication network 10, e.g., the approach provides a unified way to convey the data no matter the type of communication device. Indeed, some embodiments convey the data via the subscription concealed identifier 20 no matter whether the communication device 12 uses Extensible Authentication Protocol (EAP) authentication or 5G Authentication and Key Agreement (AKA) for authentication to the communication network 10. Alternatively or additionally, the data-type agnostic nature of the set 22 of data field(s) conveys the data in a future-proof way, e.g., so that the data conveyed by the subscription concealed identifier 20 may adapt to varying needs over time without having to re-define or re-standardize what field(s) are to be concealed by the subscription concealed identifier 20.

In some embodiments, the data-type agnostic set 22 of data field(s) may be particularly usable for conveying any data associated with the subscription 14. For example, the data-type agnostic set 22 of data field(s) may be usable for conveying data that describes communication, service, and/or network resources associated with the subscription 14, e.g., on a dynamic basis. Such data may for instance include any of: (i) data that describes a type and/or pattern of communication expected for the subscription 14; (ii) a mobility pattern expected for the subscription 14; (iii) a requirement and/or policy to be met for communication associated with the subscription 14; or (iv) a network slice and/or mobile virtual network operator associated with the subscription 14. In some embodiments, then, the data may indicate information about the subscription 14 so as to inform the communication network 10 about how the communication device 12 will behave (e.g., what type of communication it will engage in, how often those communications will happen, what communication protocols will be used, possible communication peers, etc.) and/or what the communication device 12 will need with respect to network performance, services, features, etc.

Using the data-type agnostic set 22 of data field(s) to convey these or other types of data associated with a subscription may prove particularly helpful for equipping the network 10 with data usable to tailor the network's resources and/or services to meet the needs of the subscriber at any given time. For example, the data conveyed via the data-type agnostic set 22 of data field(s) may be usable for dynamic network slicing, e.g., whereby the network 10 may dynamically orchestrate and deploy a network slice for the subscriber on demand, as needed to accommodate the properties and requirements associated with the subscription 14, such as the communication pattern and/or quality of service requirements expected for the subscription 14. Some embodiments even exploit the data for performing dynamic network slicing on a session by session basis. The data-type agnostic set 22 of data field(s) may thereby generally convey data usable by the network 10 to determine into which network slice the subscription 14 should be allocated, e.g., on a dynamic basis where the network slice suitable for the subscription 14 may vary between different data sessions.

More particularly, the data-type agnostic set 22 of data field(s) in some embodiments may be usable for conveying data that indicates a Manufacturer Usage Description (MUD) file associated with the subscription 14. The data-type agnostic set 22 of data field(s) may for example convey a Uniform Resource Identifier (URI) for the MUD file associated with the subscription 14. The MUD file may be created by the manufacturer of the communication device 12. In some embodiments, the MUD file includes information related to (i) a type and/or pattern of communication expected for the subscription 14; and/or (ii) a requirement and/or policy to be met for communication associated with the subscription 14. A pattern of communication may for instance be specified in terms of a sleep pattern used by the communication device 12, a mobility pattern of the communication device 12, and/or a type and/or frequency of communication expected for the subscription 14. Alternatively or additionally, the MUD file may specify a requirement and/or policy to be met for communication associated with the subscription 14 by specifying, for instance, (i) servers that are expected to be used for such communication; and/or (ii) latency or bandwidth requirements for the communication.

Alternatively or additionally, the data-type agnostic set 22 of data field(s) may be usable for conveying data that indicates a network token associated with the subscription 14. The data-type agnostic set 22 of data field(s) may for example convey a network token itself, or may convey a pointer to a network token.

A network token in this regard is a data structure that indicates information relevant for middleboxes in the flow in which the network token is included, e.g., as specified in Y. Yiakoumis, N. Mckeown and F. Sorensen. “Network Tokens; draft-yiakoumis-network-tokens-02.” (2020). A network token may for example instruct middleboxes on how to forward and/or treat traffic, e.g., from a quality of service (QOS) perspective. A network token may indicate traffic requirements, traffic characteristics, or service requests for on-the-path middleboxes, e.g., by specifying requirements in terms of latency, QoS, bandwidth, or other Service Level Agreement (SLA) properties. Alternatively or additionally, a network token may request specific services from the network 10, e.g., deep packet inspection (DPI), port-forwarding, public Internet Protocol (IP) addressing, firewall services, MQ Telemetry Transport (MQTT) broker services, etc. In some embodiments, indicating a network token via a subscription permanent identifier 20 for the subscription 14 binds the network token to that subscription 14.

To cater to different solutions providing these types of data to the network 10, the data-type agnostic set 22 of data field(s) may contain a type field indicating which of these types of data is conveyed, e.g. type=1 indicates the data is a *MUD URL, type=2 indicates the data is a network token, etc.

No matter the particular data conveyed, if the data-type agnostic set 22 of data field(s) is concealed in the subscription concealed identifier 20, the communication network 10 may correspondingly de-conceal that set 22 of data field(s) to retrieve the data conveyed. In some embodiments, the node in the network 10 that de-conceals the set 22 of data field(s) is the same node that uses the data conveyed by the set 22 of data field(s). In other embodiments, though, the node in the network 10 that de-conceals the set 22 of data field(s) transmits the de-concealed set 22 of data field(s) to another network node in the network 10 that uses the conveyed data. This may be the case for instance in a 5G network where the node that de-conceals the set 22 of data field(s) is or implements a Unified Data Management (UDM).

Regardless of which node in the communication network 10 extracts the data from the subscription concealed identifier 20, such as by de-concealing the data-type agnostic set 22 of data field(s), the communication network 10 according to some embodiments exploits the data to configure the communication network 10 for use by the subscription 14. For example, based on the conveyed data, a network node 50 in the communication network 10 may (i) allocate resources in the communication network 10 for use by the subscription 14; (ii) select and/or configure network services for the subscription 14; (iii) orchestrate, select, and/or configure a network slice for use by the subscription 14; (iv) configure an access network for the subscription 14; (v) configure a session for the subscription 14; and/or (vi) allocate an address for use by the subscription 14. Configuring an access network for the subscription 14 may for example involve optimizing radio resource allocation to take advantage of the device's sleep cycle. Alternatively or additionally, orchestrating a network slice for use by the subscription 14 may involve orchestrating a network slice, for use by the subscription 14, that matches a type and/or pattern of communication expected for the subscription 14 and/or that meets a requirement and/or policy to be met for communication associated with the subscription 14. Such orchestration may entail selecting which instances of network functions are deployed in the network slice and/or configuring those network function instances, e.g., where the network functions and/or the services provided by those network functions are dedicated to the network slice.

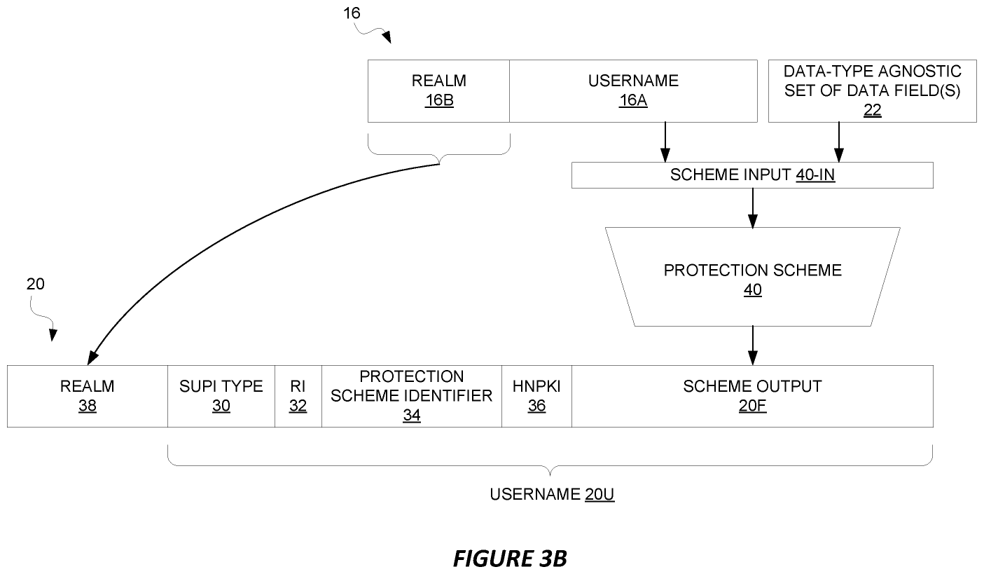

FIG. 4 illustrates additional details for conveying data via the subscription concealed identifier 20 and using that data according to some embodiments where the communication device 12 takes the form of a user equipment (UE) and the communication network 10 is a 5G network.

As shown in FIG. 4, the UE generates the subscription concealed identifier 20 in the form of a SUbscription Concealed Identifier (SUCI) (Step 1). The UE generates the SUCI with the data piggybacked thereon, as described above, e.g., by encoding the data in the SUCI. In this example, the UE generates the SUCI to convey data that provides hints on the UE's needs. The data may for example be of a type that is usable to optimize network performance and features for the UE, and to help in network and service orchestration.

In embodiments where the set 22 of data field(s) includes a type-value pair, including a value field 22A and a type field 22B, the UE sets the type field 22B to indicate the type of the data conveyed by the value field 22A, e.g., MUD=1, Network token=2, etc. In embodiments where the subscription identifier part 16A is an IMSI, the UE combines the MSIN and the type-value pair and, as a general matter, encrypts the combination with the public key of the communication network's operator. More particularly, the UE generates an ephemeral key pair, and then uses the ephemeral key pair and the public key of the operator to do an off-line Diffie-hellman key exchange and the resulting key is then used for encrypting the SUCI.

This is the same operation the UE would do in any case, with the difference being that now in addition to the MSIN, also the type-value pair is included as part of the input to the encryption. The MSIN, type, and value might be separated with some form of delimiter character, e.g. “#”, resulting in the input being: <MSIN>#<type>#<value> (or <username>#<type>#<value>for NAI type identifiers), with a concrete example being e.g. 123456789#1#http://mudserver/mudfile. When this is encrypted, the output is random looking data that together with other fields, including the MNC and MCC (or domain part of NAI), makes up the SUCI. In some embodiments, multiple type-value pairs can be included in one SUCI, e.g. <MSIN>#<type1>#<value1>#<type2>#<value2> . . . In this case it could be possible to encode the data in type-length-value (TLV) tuples for easier parsing; in this case delimiter characters might not be needed as the length indicates where next TLV starts.

In Steps 2, 3, and 4, the SUCI is included in the registration request and forwarded to the UDM.

In Step 5, the SUCI is processed in the wireless communication network 10, in particular, the 5G core network. When the SUCI is received by the 5G core network in the registration message from the UE, the SUCI is deconcealed by the UDM, i.e. the encrypted part is decrypted. The network 10 will find both the MSIN and the set 22 of data field(s) added by the UE. The subscription 14 can be located from the operator databases based on the MSIN. In some embodiments, the UDM (/SIDF/ARPF) is the function deconcealing the SUCI and looking up subscription information, where the SIDF is the Subscription Identifier De-Concealing Function (SIDF) and the ARPF is the Authentication credential Repository Processing Function (ARPF).

In steps 6 and 7, the SUPI resulting from deconcealing is sent back to the Authentication Server Function (AUSF) together with relevant subscription information. Likewise, the UDM may then provide the extracted type-value pair(s) to the AUSF (or other network function, NF, that would utilize the info).

In Step 8, one or more network functions in the network 10 then process the received data. The network function(s) in some embodiments include a network function dedicated to processing the data. In other embodiments shown, though, the network function(s) that process the data include the AUSF by itself, or the AUSF together with SMF (session management function), AMF (access and mobility management function), NSSF (network slice selection function) or PCF (policy control function). In FIG. 4, the example has the AMF provide the data to the SMF, which then processes and applies the data to the session. However, other network functions could also be involved, and AUSF could e.g. communicate the set 22 of data field(s) directly to SMF.

The “legacy” subscription info might contain information related to how the subscription 14 should be handled, e.g. slices available for the subscription 14. In addition to using the data communicated in the set 22 of data field(s), then, the network 10 might also use “legacy” information found in the subscription 14, to select and tailor the session/connection of the UE.

The information that can be gathered based on the set 22 of data field(s) can further help the network 10 to configure the session of the UE. For the set 22 of data field(s) the network 10 also may perform some new functions based on the conveyed data. Where the set 22 of data field(s) includes type-value pair(s), the network 10 may first looks at the type to determine what type of data is included, and based on that it starts to utilize the received data.

For example, if the data conveyed indicates a MUD file, the AMF in Step 9 expects to find a MUD URL as the value conveyed, extracts the MUD URL from the deconcealed data, and provides the MUD URL to the SMF. In step 10, then, the SMF acts as a MUD manager and contacts the MUD server indicated by the MUD URL and downloads the MUD file. The SMF parses the MUD file and extracts relevant information such as (i) expected communication patterns, including e.g. possible sleep patterns, mobility, transmission frequency and type; (ii) communication policies/end-points (e.g. servers that will typically be used etc.); and/or (iii) communication requirements e.g. related to latency or bandwidth. Based on the extracted information, the SMF in Step 11 tries to optimize and customize the connection/session of the subscription. For example, the SMF may trigger and/or perform selection, generation, and/or configuration of a suitable slice, e.g., including (i) selecting suitable services for the slice, such as deep packet inspection, proxying etc.; (ii) dynamically creating a slice for the UE/subscription; (iii) configuring the access network based on e.g. sleep pattern or mobility expectation; (iv) allocating suitable IP address (e.g. if acting as server provide public IP address or port forwarding); (v) configuring a firewall for the UE/subscription; and/or (vi) configuring NEF (network exposure function) to allow connections from the public network.

These and other embodiments herein may therefore use the conveyed MUD file to limit the communication of the UE to the communication patterns indicated by the MUD file and thereby improve security of the UE. Some embodiments alternatively or additionally use the MUD file for configuring the access network to fit the requirements of the UE, e.g. related to reachability through NATs etc.

Note, these steps can be carried out in parallel with the registration exchange.

Alternatively or additionally, if the data conveyed indicates a network token, the AMF in Step 12 expects to find a network token, extracts the network token, and provides the network token to the SMF. The SMF, optionally after fetching the network token from the indicated network location, finds out what type of service the subscription/UE is requesting. For example, a network token could indicate the network services requested, such as DPI, reachability requirements related information (network address translation port forwarding), and creation and expiration times of the token) etc., e.g.: {“srv”:“DPI”, “nat”:80, “exp”:34411767652}. The token might also specify requirements in terms of Latency, QoS, bandwidth etc. If the subscription 14 allows, the SMF in Step 13 may try to provide a suitable session that fulfills the requirements, e.g. by triggering and/or performing allocation (selection or creation) of a suitable slice for the UE, configuring NAT etc.

On the other hand, if the data conveyed is of some other type, data type specific operations may be performed by the network instead.

Note further that, in some embodiments, the set 22 of data field(s) may include multiple type-value pairs. An example could be to include the slice identifier to indicate what slice the UE wants to be assigned and to also include a MUD URL to provide communication characteristics for the benefit of the network.

As this example demonstrates, then, the UDM in some embodiments deconceals the SUCI and extracts the additional data encoded in the encrypted part of the SUCI. The UDM may then either provide this additional data to the AUSF which invoked the UDM with the SUCI, or directly to an orchestration NF. If the AUSF gets the data, the AUSF may provide it to the orchestration NF, directly or indirectly. The Orchestration NF might then poll various other NFs for additional info related to the subscription, especially the PCF, and optionally also external resources such as the MUD server for example. After the orchestration NF has all the data, it can merge it and then orchestrate the network accordingly.

Generally, the communication network 10 gathers data about the subscriber/session (i.e. information received via MUD file, network token, application token, local policy information etc.). Based on this data, the network 10 compiles the optimal configuration for serving the subscriber and then applies this configuration to the network, e.g. by creating a dedicated slice or configuring session parameters in the network. Involved network functions could include session management function (SMF), policy control function (PCF), and network slice selection function (NSSF), but could also involve a potential new NF doing some form of orchestration of the network. The access and mobility management function (AMF) might also be involved and benefit from some of the conveyed data. The configuration could affect various parts of the network as well, including user plane function (UPF), network exposure function (NEF), SMF, RAN, and various services running in the core network.

Certain embodiments may provide one or more of the following technical advantage(s). Piggybacking UE/subscription relevant data in the SUCI in an extendable way allows for future data types to be communicated. By getting more data about how to best serve a single subscriber, possibly even for a single session, the network 10 may optimize network slicing accordingly, on a more dynamic basis. This contrasts with existing network slicing practices where slices are pre-configured, and typically operators only have a few slices to which all the subscribers are allocated based on need and authorization.

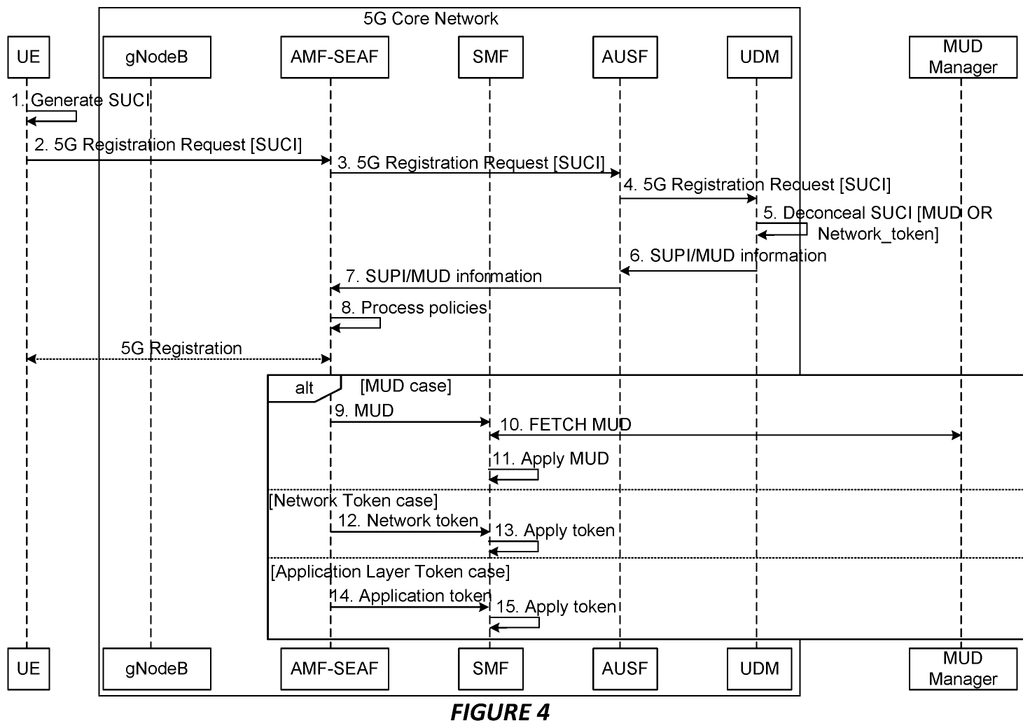

In view of the modifications and variations herein, FIG. 5 depicts a method performed by a communication device 12 configured for use in a communication network 10 10 in accordance with particular embodiments. The method includes generating a subscription concealed identifier 20 that conceals a subscription identifier part 16A of a subscription permanent identifier 16 and conceals a set 22 of one or more data fields which is agnostic as to a type of data that the set 22 conveys (Block 100). The method further comprises transmitting the subscription concealed identifier 20 (Block 110).

In some embodiments, the set 22 of one or more data fields include a value field 22A and a type field 22B. In this case, the value field 22A conveys the data and the type field 22B indicates a type of the data conveyed. Additionally or alternatively, the set 22 of one or more data fields include a value field 22A, a length field, and a type field 22B. In this case, the value field 22A conveys the data, the type field 22B indicates a type of the data conveyed, and the length field 22C indicates a length of the value field 22A or a length of the set 22 of one or more fields.

In some embodiments, the set 22 of one or more data fields conveys data describing communication, service, and/or network resources associated with a subscription identified by the subscription permanent identifier 16. In one or more of these embodiments, the data describes a type and/or pattern of communication expected for the subscription, and/or a mobility pattern expected for the subscription, and/or a requirement and/or policy to be met for communication associated with the subscription. In one or more of these embodiments, the data indicates a Manufacturer Usage Description, MUD, file associated with the subscription. In one or more of these embodiments, the data indicates a network token associated with the subscription. In one or more of these embodiments, the network resources associated with the subscription include a network slice and/or a mobile virtual network operator associated with the subscription.

In some embodiments, generating a subscription concealed identifier 20 comprises constructing a scheme input from the subscription identifier part 16A and from the set 22 of one or more data fields, executing a protection scheme with the constructed scheme input as input, to obtain a scheme output, and constructing the subscription concealed identifier 20 with a data field that contains the scheme output.

In some embodiments, transmitting the subscription concealed identifier 20 comprises transmitting the subscription concealed identifier 20 in a registration request or a service request to the communication network 10.

In some embodiments, the subscription concealed identifier 20 is a SUbscription Concealed Identifier, SUCI, and the subscription permanent identifier 16 is a SUbscription Permanent Identifier, SUPI.

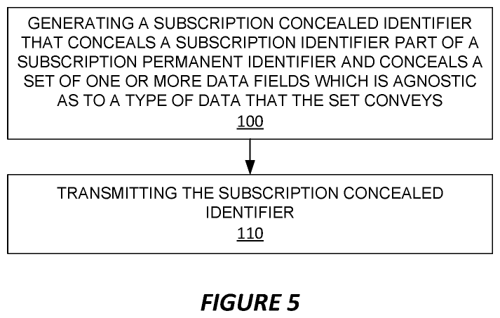

FIG. 6A depicts a method performed by a network node 50 configured for use in a communication network 10 in accordance with other particular embodiments. The method includes receiving a subscription concealed identifier 20 that conceals a subscription identifier part 16A of a subscription permanent identifier 16 and conceals a set 22 of one or more data fields which is agnostic as to a type of data that the set 22 conveys (Block 200).

In some embodiments, the set 22 of one or more data fields include a value field 22A and a type field 22B. In this case, the value field 22A conveys the data and the type field 22B indicates a type of the data conveyed. Additionally or alternatively, the set 22 of one or more data fields include a value field 22A, a length field 22C, and a type field 22B. In this case, the value field 22A conveys the data, the type field 22B indicates a type of the data conveyed, and the length field 22C indicates a length of the value field 22A or a length of the set 22 of one or more fields.

In some embodiments, the set 22 of one or more data fields conveys data describing communication, service, and/or network resources associated with a subscription identified by the subscription permanent identifier 16. In one or more of these embodiments, the data describes a type and/or pattern of communication expected for the subscription, and/or a mobility pattern expected for the subscription, and/or a requirement and/or policy to be met for communication associated with the subscription. In one or more of these embodiments, the data indicates a Manufacturer Usage Description, MUD, file associated with the subscription. In one or more of these embodiments, the data indicates a network token associated with the subscription. In one or more of these embodiments, the network resources associated with the subscription include a network slice. Additionally or alternatively, the network resources associated with the subscription include a mobile virtual network operator associated with the subscription.

In one or more embodiments, the method further comprises, based on the conveyed data, configuring the communication network 10 for use by the subscription (Block 200). In one or more of these embodiments, configuring the communication network 10 comprises one or more of allocating resources in the communication network 10 for use by the subscription, selecting and/or configuring network services for the subscription, orchestrating, selecting, and/or configuring a network slice for use by the subscription, configuring an access network for the subscription, configuring a session for the subscription, or allocating an address to for use by the subscription. In one or more of these embodiments, configuring the communication network 10 comprises orchestrating a network slice, for use by the subscription, that matches a type and/or pattern of communication expected for the subscription and/or that meets a requirement and/or policy to be met for communication associated with the subscription.

In some embodiments, receiving a subscription concealed identifier 20 comprises receiving the subscription concealed identifier 20 in a registration request or a service request from a communication device.

In some embodiments, the subscription concealed identifier 20 is a SUbscription Concealed Identifier, SUCI, and the subscription permanent identifier 16 is a SUbscription Permanent Identifier, SUPI.

In some embodiments, the method further comprises de-concealing the subscription identifier part 16A and/or the set 22 of one or more data fields, and transmitting at least the de-concealed subscription identifier part 16A and/or the set 22 of one or more data fields to another network node in the communication network 10.

FIG. 6B depicts a method performed by a network node 50 configured for use in a communication network 10 in accordance with still other particular embodiments. The method includes receiving data from a communication device 12 describing a type and/or pattern of communication expected for a subscription associated with the communication device 12 and/or describing a requirement and/or policy to be met for communication associated with the subscription (Block 250). The method also comprises, based on the received data, orchestrating the communication network 10 for use by the subscription (Block 260).

In some embodiments, such orchestrating comprises allocating resources in the communication network 10 for use by the subscription, selecting and/or configuring network services for the subscription, orchestrating, selecting, and/or configuring a network slice for use by the subscription, configuring an access network for the subscription, configuring a session for the subscription, or allocating an address to for use by the subscription. In one or more of these embodiments, orchestrating the communication network 10 comprises orchestrating a network slice, for use by the subscription, that matches the type and/or pattern of communication expected for the subscription and/or that meets the requirement and/or policy to be met for communication associated with the subscription.

Embodiments herein also include corresponding apparatuses. Embodiments herein for instance include a communication device 12 configured to perform any of the steps of any of the embodiments described above for the communication device 12.

Embodiments also include a communication device 12 comprising processing circuitry and power supply circuitry. The processing circuitry is configured to perform any of the steps of any of the embodiments described above for the communication device 12. The power supply circuitry is configured to supply power to the communication device 12.

Embodiments further include a communication device 12 comprising processing circuitry. The processing circuitry is configured to perform any of the steps of any of the embodiments described above for the communication device 12. In some embodiments, the communication device 12 further comprises communication circuitry.

Embodiments further include a communication device 12 comprising processing circuitry and memory. The memory contains instructions executable by the processing circuitry whereby the communication device 12 is configured to perform any of the steps of any of the embodiments described above for the communication device 12.

Embodiments moreover include a user equipment (UE). The UE comprises an antenna configured to send and receive wireless signals. The UE also comprises radio front-end circuitry connected to the antenna and to processing circuitry, and configured to condition signals communicated between the antenna and the processing circuitry. The processing circuitry is configured to perform any of the steps of any of the embodiments described above for the communication device 12. In some embodiments, the UE also comprises an input interface connected to the processing circuitry and configured to allow input of information into the UE to be processed by the processing circuitry. The UE may comprise an output interface connected to the processing circuitry and configured to output information from the UE that has been processed by the processing circuitry. The UE may also comprise a battery connected to the processing circuitry and configured to supply power to the UE.

Embodiments herein also include a network node 50 configured to perform any of the steps of any of the embodiments described above for the network node 50.

Embodiments also include a network node 50 comprising processing circuitry and power supply circuitry. The processing circuitry is configured to perform any of the steps of any of the embodiments described above for the network node 50. The power supply circuitry is configured to supply power to the network node 50.

Embodiments further include a network node 50 comprising processing circuitry. The processing circuitry is configured to perform any of the steps of any of the embodiments described above for the network node 50. In some embodiments, the network node 50 further comprises communication circuitry.

Embodiments further include a network node 50 comprising processing circuitry and memory. The memory contains instructions executable by the processing circuitry whereby the network node 50 is configured to perform any of the steps of any of the embodiments described above for the network node 50.

More particularly, the apparatuses described above may perform the methods herein and any other processing by implementing any functional means, modules, units, or circuitry. In one embodiment, for example, the apparatuses comprise respective circuits or circuitry configured to perform the steps shown in the method figures. The circuits or circuitry in this regard may comprise circuits dedicated to performing certain functional processing and/or one or more microprocessors in conjunction with memory. For instance, the circuitry may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory may include program instructions for executing one or more telecommunications and/or data communications protocols as well as instructions for carrying out one or more of the techniques described herein, in several embodiments. In embodiments that employ memory, the memory stores program code that, when executed by the one or more processors, carries out the techniques described herein.

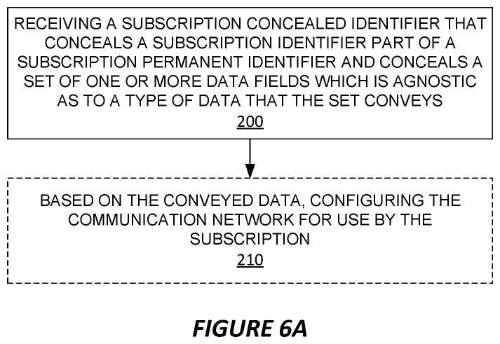

FIG. 7 for example illustrates a communication device 12 as implemented in accordance with one or more embodiments. As shown, the communication device 12 includes processing circuitry 710 and communication circuitry 720. The communication circuitry 720 (e.g., radio circuitry) is configured to transmit and/or receive information to and/or from one or more other nodes, e.g., via any communication technology. Such communication may occur via one or more antennas that are either internal or external to the communication device 12. The processing circuitry 710 is configured to perform processing described above, e.g., in FIG. 5, such as by executing instructions stored in memory 730. The processing circuitry 710 in this regard may implement certain functional means, units, or modules.

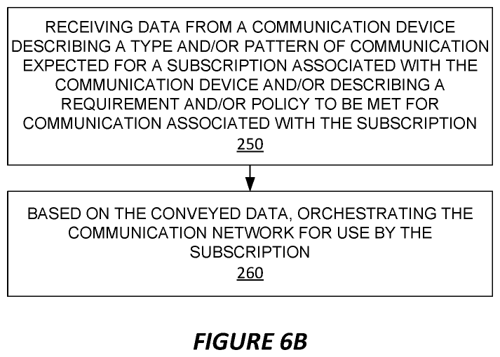

FIG. 8 illustrates a network node 50 as implemented in accordance with one or more embodiments. As shown, the network node 50 includes processing circuitry 810 and communication circuitry 820. The communication circuitry 820 is configured to transmit and/or receive information to and/or from one or more other nodes, e.g., via any communication technology. The processing circuitry 810 is configured to perform processing described above, e.g., in FIG. 6A or FIG. 6B, such as by executing instructions stored in memory 830. The processing circuitry 810 in this regard may implement certain functional means, units, or modules.

Those skilled in the art will also appreciate that embodiments herein further include corresponding computer programs.

A computer program comprises instructions which, when executed on at least one processor of an apparatus, cause the apparatus to carry out any of the respective processing described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of an apparatus, cause the apparatus to perform as described above.

Embodiments further include a computer program product comprising program code portions for performing the steps of any of the embodiments herein when the computer program product is executed by a computing device. This computer program product may be stored on a computer readable recording medium.

Although some steps herein have been described as being performed by a network node, such does not preclude the steps as being performed more specifically by a network function (NF), e.g., as defined in a 5G network. In this case, a network function may be implemented by a network node, such that performance of a step by the network function may generally be said to amount to performance of the step by the network node.

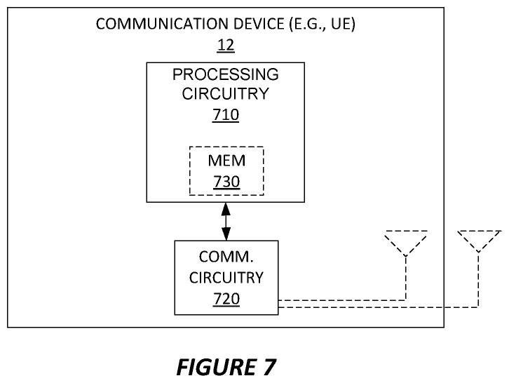

FIG. 9 shows an example of a communication system 900 in accordance with some embodiments.

In the example, the communication system 900 includes a telecommunication network 902 that includes an access network 904, such as a radio access network (RAN), and a core network 906, which includes one or more core network nodes 908. The access network 904 includes one or more access network nodes, such as network nodes 910a and 910b (one or more of which may be generally referred to as network nodes 910), or any other similar 3^{rd} Generation Partnership Project (3GPP) access node or non-3GPP access point. The network nodes 910 facilitate direct or indirect connection of user equipment (UE), such as by connecting UEs 912a, 912b, 912c, and 912d (one or more of which may be generally referred to as UEs 912) to the core network 906 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 900 may include any number of wired or wireless networks, network nodes, UEs, and/or any other components or systems that may facilitate or participate in the communication of data and/or signals whether via wired or wireless connections. The communication system 900 may include and/or interface with any type of communication, telecommunication, data, cellular, radio network, and/or other similar type of system.

The UEs 912 may be any of a wide variety of communication devices, including wireless devices arranged, configured, and/or operable to communicate wirelessly with the network nodes 910 and other communication devices. Similarly, the network nodes 910 are arranged, capable, configured, and/or operable to communicate directly or indirectly with the UEs 912 and/or with other network nodes or equipment in the telecommunication network 902 to enable and/or provide network access, such as wireless network access, and/or to perform other functions, such as administration in the telecommunication network 902.

In the depicted example, the core network 906 connects the network nodes 910 to one or more hosts, such as host 916. These connections may be direct or indirect via one or more intermediary networks or devices. In other examples, network nodes may be directly coupled to hosts. The core network 906 includes one more core network nodes (e.g., core network node 908) that are structured with hardware and software components. Features of these components may be substantially similar to those described with respect to the UEs, network nodes, and/or hosts, such that the descriptions thereof are generally applicable to the corresponding components of the core network node 908. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 916 may be under the ownership or control of a service provider other than an operator or provider of the access network 904 and/or the telecommunication network 902, and may be operated by the service provider or on behalf of the service provider. The host 916 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 900 of FIG. 9 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 902 is a cellular network that implements 3GPP standardized features. Accordingly, the telecommunications network 902 may support network slicing to provide different logical networks to different devices that are connected to the telecommunication network 902. For example, the telecommunications network 902 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 912 are configured to transmit and/or receive information without direct human interaction. For instance, a UE may be designed to transmit information to the access network 904 on a predetermined schedule, when triggered by an internal or external event, or in response to requests from the access network 904. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 914 communicates with the access network 904 to facilitate indirect communication between one or more UEs (e.g., UE 912c and/or 912d) and network nodes (e.g., network node 910b). In some examples, the hub 914 may be a controller, router, content source and analytics, or any of the other communication devices described herein regarding UEs. For example, the hub 914 may be a broadband router enabling access to the core network 906 for the UEs. As another example, the hub 914 may be a controller that sends commands or instructions to one or more actuators in the UEs. Commands or instructions may be received from the UEs, network nodes 910, or by executable code, script, process, or other instructions in the hub 914. As another example, the hub 914 may be a data collector that acts as temporary storage for UE data and, in some embodiments, may perform analysis or other processing of the data. As another example, the hub 914 may be a content source. For example, for a UE that is a VR headset, display, loudspeaker or other media delivery device, the hub 914 may retrieve VR assets, video, audio, or other media or data related to sensory information via a network node, which the hub 914 then provides to the UE either directly, after performing local processing, and/or after adding additional local content. In still another example, the hub 914 acts as a proxy server or orchestrator for the UEs, in particular in if one or more of the UEs are low energy IoT devices.

The hub 914 may have a constant/persistent or intermittent connection to the network node 910b. The hub 914 may also allow for a different communication scheme and/or schedule between the hub 914 and UEs (e.g., UE 912c and/or 912d), and between the hub 914 and the core network 906. In other examples, the hub 914 is connected to the core network 906 and/or one or more UEs via a wired connection. Moreover, the hub 914 may be configured to connect to an M2M service provider over the access network 904 and/or to another UE over a direct connection. In some scenarios, UEs may establish a wireless connection with the network nodes 910 while still connected via the hub 914 via a wired or wireless connection. In some embodiments, the hub 914 may be a dedicated hub—that is, a hub whose primary function is to route communications to/from the UEs from/to the network node 910b. In other embodiments, the hub 914 may be a non-dedicated hub—that is, a device which is capable of operating to route communications between the UEs and network node 910b, but which is additionally capable of operating as a communication start and/or end point for certain data channels.

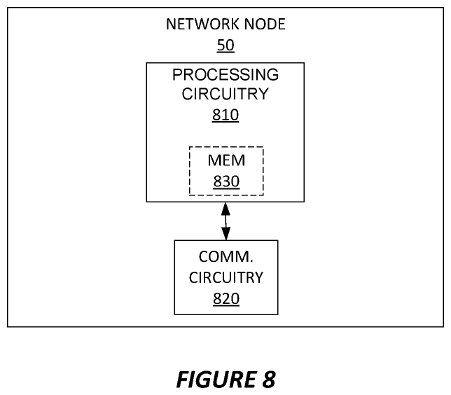

FIG. 10 shows a UE 1000 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1000 includes processing circuitry 1002 that is operatively coupled via a bus 1004 to an input/output interface 1006, a power source 1008, a memory 1010, a communication interface 1012, and/or any other component, or any combination thereof. Certain UEs may utilize all or a subset of the components shown in FIG. 10. The level of integration between the components may vary from one UE to another UE. Further, certain UEs may contain multiple instances of a component, such as multiple processors, memories, transceivers, transmitters, receivers, etc.

The processing circuitry 1002 is configured to process instructions and data and may be configured to implement any sequential state machine operative to execute instructions stored as machine-readable computer programs in the memory 1010. The processing circuitry 1002 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1002 may include multiple central processing units (CPUs).

In the example, the input/output interface 1006 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1000. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1008 is structured as a battery or battery pack. Other types of power sources, such as an external power source (e.g., an electricity outlet), photovoltaic device, or power cell, may be used. The power source 1008 may further include power circuitry for delivering power from the power source 1008 itself, and/or an external power source, to the various parts of the UE 1000 via input circuitry or an interface such as an electrical power cable. Delivering power may be, for example, for charging of the power source 1008. Power circuitry may perform any formatting, converting, or other modification to the power from the power source 1008 to make the power suitable for the respective components of the UE 1000 to which power is supplied.

The memory 1010 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1010 includes one or more application programs 1014, such as an operating system, web browser application, a widget, gadget engine, or other application, and corresponding data 1016. The memory 1010 may store, for use by the UE 1000, any of a variety of various operating systems or combinations of operating systems.

The memory 1010 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1010 may allow the UE 1000 to access instructions, application programs and the like, stored on transitory or non-transitory memory media, to off-load data, or to upload data. An article of manufacture, such as one utilizing a communication system may be tangibly embodied as or in the memory 1010, which may be or comprise a device-readable storage medium.

The processing circuitry 1002 may be configured to communicate with an access network or other network using the communication interface 1012. The communication interface 1012 may comprise one or more communication subsystems and may include or be communicatively coupled to an antenna 1022. The communication interface 1012 may include one or more transceivers used to communicate, such as by communicating with one or more remote transceivers of another device capable of wireless communication (e.g., another UE or a network node in an access network). Each transceiver may include a transmitter 1018 and/or a receiver 1020 appropriate to provide network communications (e.g., optical, electrical, frequency allocations, and so forth). Moreover, the transmitter 1018 and receiver 1020 may be coupled to one or more antennas (e.g., antenna 1022) and may share circuit components, software or firmware, or alternatively be implemented separately.

In the illustrated embodiment, communication functions of the communication interface 1012 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1012, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1000 shown in FIG. 10.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

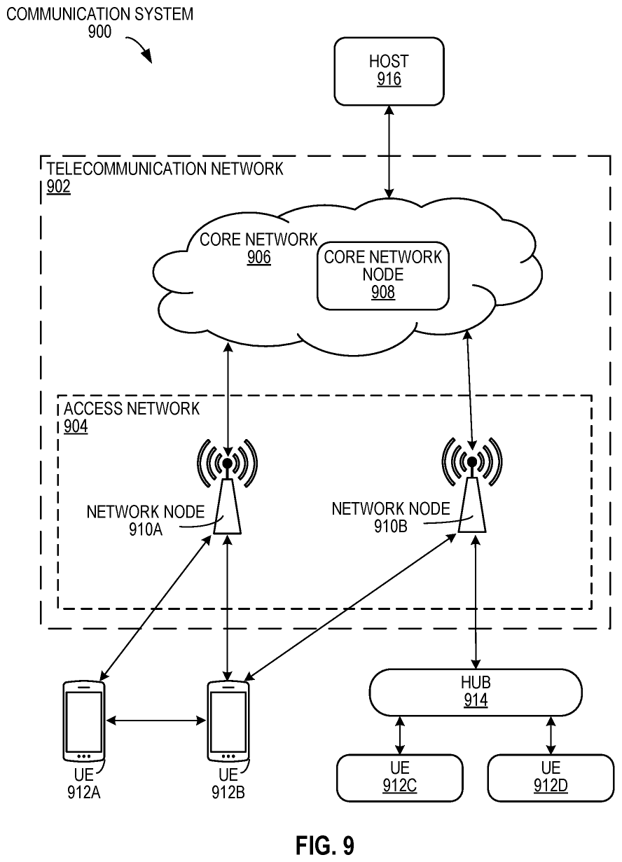

FIG. 11 shows a network node 1100 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1100 includes a processing circuitry 1102, a memory 1104, a communication interface 1106, and a power source 1108. The network node 1100 may be composed of multiple physically separate components (e.g., a NodeB component and a RNC component, or a BTS component and a BSC component, etc.), which may each have their own respective components. In certain scenarios in which the network node 1100 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1100 may be configured to support multiple radio access technologies (RATs). In such embodiments, some components may be duplicated (e.g., separate memory 1104 for different RATs) and some components may be reused (e.g., a same antenna 1110 may be shared by different RATs). The network node 1100 may also include multiple sets of the various illustrated components for different wireless technologies integrated into network node 1100, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1100.

The processing circuitry 1102 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1100 components, such as the memory 1104, to provide network node 1100 functionality.

In some embodiments, the processing circuitry 1102 includes a system on a chip (SOC). In some embodiments, the processing circuitry 1102 includes one or more of radio frequency (RF) transceiver circuitry 1112 and baseband processing circuitry 1114. In some embodiments, the radio frequency (RF) transceiver circuitry 1112 and the baseband processing circuitry 1114 may be on separate chips (or sets of chips), boards, or units, such as radio units and digital units. In alternative embodiments, part or all of RF transceiver circuitry 1112 and baseband processing circuitry 1114 may be on the same chip or set of chips, boards, or units.

The memory 1104 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1102. The memory 1104 may store any suitable instructions, data, or information, including a computer program, software, an application including one or more of logic, rules, code, tables, and/or other instructions capable of being executed by the processing circuitry 1102 and utilized by the network node 1100. The memory 1104 may be used to store any calculations made by the processing circuitry 1102 and/or any data received via the communication interface 1106. In some embodiments, the processing circuitry 1102 and memory 1104 is integrated.

The communication interface 1106 is used in wired or wireless communication of signaling and/or data between a network node, access network, and/or UE. As illustrated, the communication interface 1106 comprises port(s)/terminal(s) 1116 to send and receive data, for example to and from a network over a wired connection. The communication interface 1106 also includes radio front-end circuitry 1118 that may be coupled to, or in certain embodiments a part of, the antenna 1110. Radio front-end circuitry 1118 comprises filters 1120 and amplifiers 1122. The radio front-end circuitry 1118 may be connected to an antenna 1110 and processing circuitry 1102. The radio front-end circuitry may be configured to condition signals communicated between antenna 1110 and processing circuitry 1102. The radio front-end circuitry 1118 may receive digital data that is to be sent out to other network nodes or UEs via a wireless connection. The radio front-end circuitry 1118 may convert the digital data into a radio signal having the appropriate channel and bandwidth parameters using a combination of filters 1120 and/or amplifiers 1122. The radio signal may then be transmitted via the antenna 1110. Similarly, when receiving data, the antenna 1110 may collect radio signals which are then converted into digital data by the radio front-end circuitry 1118. The digital data may be passed to the processing circuitry 1102. In other embodiments, the communication interface may comprise different components and/or different combinations of components.

In certain alternative embodiments, the network node 1100 does not include separate radio front-end circuitry 1118, instead, the processing circuitry 1102 includes radio front-end circuitry and is connected to the antenna 1110. Similarly, in some embodiments, all or some of the RF transceiver circuitry 1112 is part of the communication interface 1106. In still other embodiments, the communication interface 1106 includes one or more ports or terminals 1116, the radio front-end circuitry 1118, and the RF transceiver circuitry 1112, as part of a radio unit (not shown), and the communication interface 1106 communicates with the baseband processing circuitry 1114, which is part of a digital unit (not shown).

The antenna 1110 may include one or more antennas, or antenna arrays, configured to send and/or receive wireless signals. The antenna 1110 may be coupled to the radio front-end circuitry 1118 and may be any type of antenna capable of transmitting and receiving data and/or signals wirelessly. In certain embodiments, the antenna 1110 is separate from the network node 1100 and connectable to the network node 1100 through an interface or port.

The antenna 1110, communication interface 1106, and/or the processing circuitry 1102 may be configured to perform any receiving operations and/or certain obtaining operations described herein as being performed by the network node. Any information, data and/or signals may be received from a UE, another network node and/or any other network equipment. Similarly, the antenna 1110, the communication interface 1106, and/or the processing circuitry 1102 may be configured to perform any transmitting operations described herein as being performed by the network node. Any information, data and/or signals may be transmitted to a UE, another network node and/or any other network equipment.

The power source 1108 provides power to the various components of network node 1100 in a form suitable for the respective components (e.g., at a voltage and current level needed for each respective component). The power source 1108 may further comprise, or be coupled to, power management circuitry to supply the components of the network node 1100 with power for performing the functionality described herein. For example, the network node 1100 may be connectable to an external power source (e.g., the power grid, an electricity outlet) via an input circuitry or interface such as an electrical cable, whereby the external power source supplies power to power circuitry of the power source 1108. As a further example, the power source 1108 may comprise a source of power in the form of a battery or battery pack which is connected to, or integrated in, power circuitry. The battery may provide backup power should the external power source fail.

Embodiments of the network node 1100 may include additional components beyond those shown in FIG. 11 for providing certain aspects of the network node's functionality, including any of the functionality described herein and/or any functionality necessary to support the subject matter described herein. For example, the network node 1100 may include user interface equipment to allow input of information into the network node 1100 and to allow output of information from the network node 1100. This may allow a user to perform diagnostic, maintenance, repair, and other administrative functions for the network node 1100.

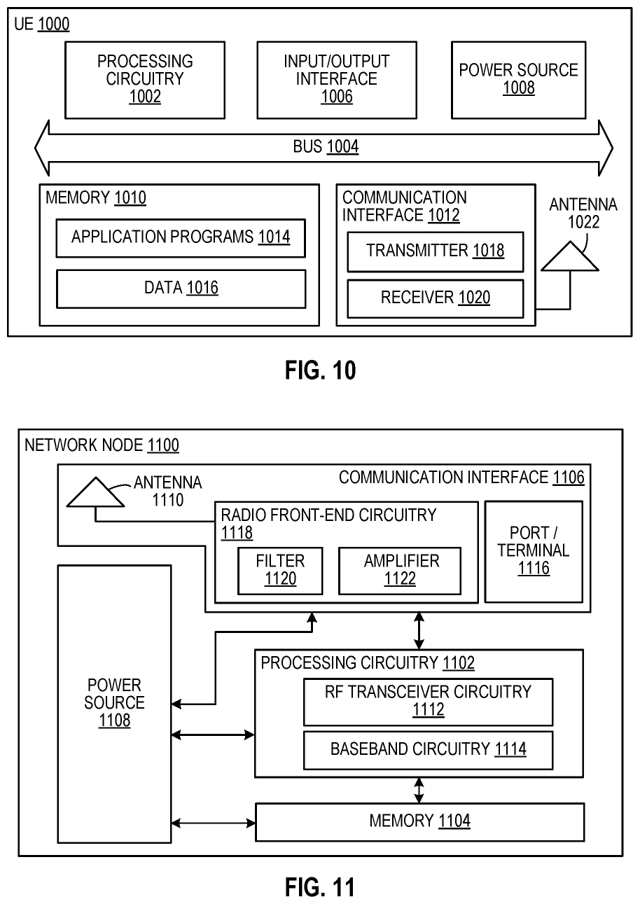

FIG. 12 is a block diagram of a host 1200, which may be an embodiment of the host 916 of FIG. 9, in accordance with various aspects described herein. As used herein, the host 1200 may be or comprise various combinations hardware and/or software, including a standalone server, a blade server, a cloud-implemented server, a distributed server, a virtual machine, container, or processing resources in a server farm. The host 1200 may provide one or more services to one or more UEs.

The host 1200 includes processing circuitry 1202 that is operatively coupled via a bus 1204 to an input/output interface 1206, a network interface 1208, a power source 1210, and a memory 1212. Other components may be included in other embodiments. Features of these components may be substantially similar to those described with respect to the devices of previous figures, such as FIGS. 10 and 11, such that the descriptions thereof are generally applicable to the corresponding components of host 1200.

The memory 1212 may include one or more computer programs including one or more host application programs 1214 and data 1216, which may include user data, e.g., data generated by a UE for the host 1200 or data generated by the host 1200 for a UE. Embodiments of the host 1200 may utilize only a subset or all of the components shown. The host application programs 1214 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1214 may also provide for user authentication and licensing checks and may periodically report health, routes, and content availability to a central node, such as a device in or on the edge of a core network. Accordingly, the host 1200 may select and/or indicate a different host for over-the-top services for a UE. The host application programs 1214 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

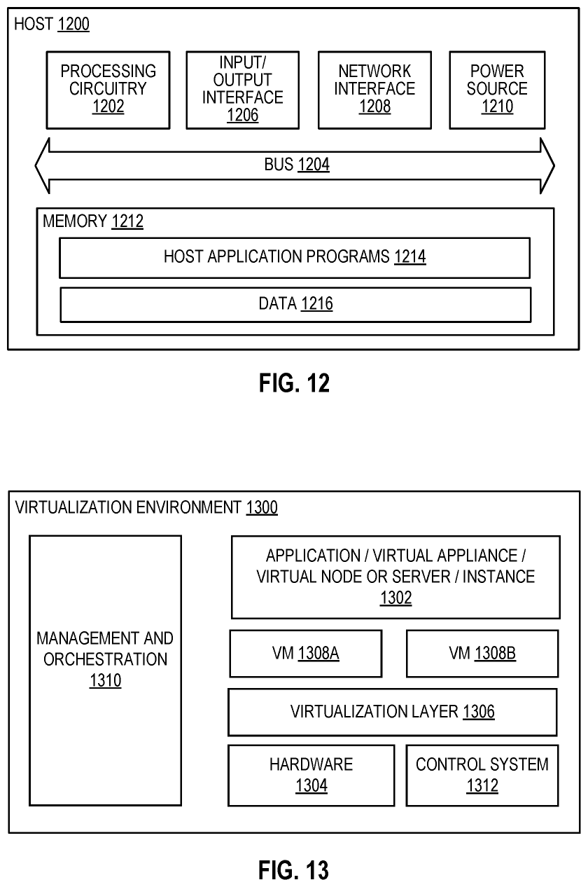

FIG. 13 is a block diagram illustrating a virtualization environment 1300 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1300 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1302 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1304 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1306 (also referred to as hypervisors or virtual machine monitors (VMMs)), provide VMs 1308a and 1308b (one or more of which may be generally referred to as VMs 1308), and/or perform any of the functions, features and/or benefits described in relation with some embodiments described herein. The virtualization layer 1306 may present a virtual operating platform that appears like networking hardware to the VMs 1308.

The VMs 1308 comprise virtual processing, virtual memory, virtual networking or interface and virtual storage, and may be run by a corresponding virtualization layer 1306. Different embodiments of the instance of a virtual appliance 1302 may be implemented on one or more of VMs 1308, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1308 may be a software implementation of a physical machine that runs programs as if they were executing on a physical, non-virtualized machine. Each of the VMs 1308, and that part of hardware 1304 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1308 on top of the hardware 1304 and corresponds to the application 1302.

Hardware 1304 may be implemented in a standalone network node with generic or specific components. Hardware 1304 may implement some functions via virtualization. Alternatively, hardware 1304 may be part of a larger cluster of hardware (e.g. such as in a data center or CPE) where many hardware nodes work together and are managed via management and orchestration 1310, which, among others, oversees lifecycle management of applications 1302. In some embodiments, hardware 1304 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1312 which may alternatively be used for communication between hardware nodes and radio units.

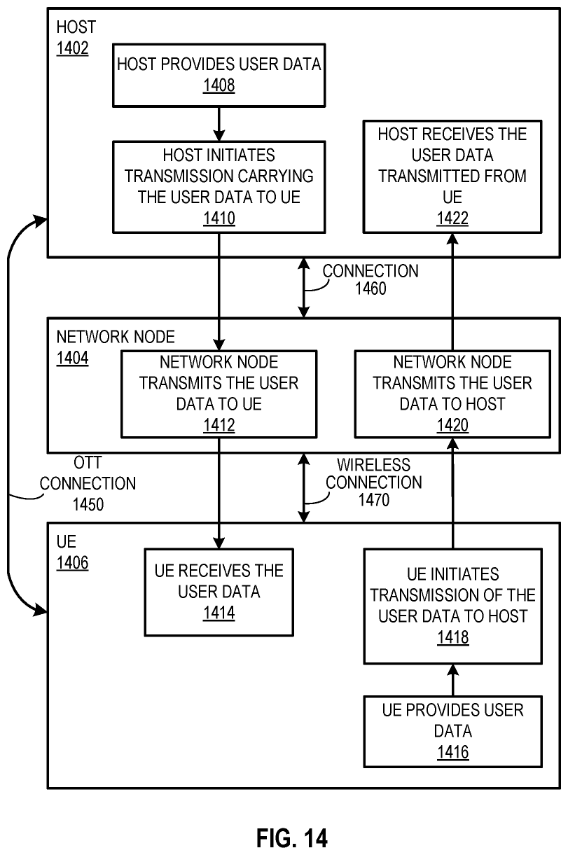

FIG. 14 shows a communication diagram of a host 1402 communicating via a network node 1404 with a UE 1406 over a partially wireless connection in accordance with some embodiments. Example implementations, in accordance with various embodiments, of the UE (such as a UE 912a of FIG. 9 and/or UE 1000 of FIG. 10), network node (such as network node 910a of FIG. 9 and/or network node 1100 of FIG. 11), and host (such as host 916 of FIG. 9 and/or host 1200 of FIG. 12) discussed in the preceding paragraphs will now be described with reference to FIG. 14.

Like host 1200, embodiments of host 1402 include hardware, such as a communication interface, processing circuitry, and memory. The host 1402 also includes software, which is stored in or accessible by the host 1402 and executable by the processing circuitry. The software includes a host application that may be operable to provide a service to a remote user, such as the UE 1406 connecting via an over-the-top (OTT) connection 1450 extending between the UE 1406 and host 1402. In providing the service to the remote user, a host application may provide user data which is transmitted using the OTT connection 1450.

The network node 1404 includes hardware enabling it to communicate with the host 1402 and UE 1406. The connection 1460 may be direct or pass through a core network (like core network 906 of FIG. 9) and/or one or more other intermediate networks, such as one or more public, private, or hosted networks. For example, an intermediate network may be a backbone network or the Internet.

The UE 1406 includes hardware and software, which is stored in or accessible by UE 1406 and executable by the UE's processing circuitry. The software includes a client application, such as a web browser or operator-specific “app” that may be operable to provide a service to a human or non-human user via UE 1406 with the support of the host 1402. In the host 1402, an executing host application may communicate with the executing client application via the OTT connection 1450 terminating at the UE 1406 and host 1402. In providing the service to the user, the UE's client application may receive request data from the host's host application and provide user data in response to the request data. The OTT connection 1450 may transfer both the request data and the user data. The UE's client application may interact with the user to generate the user data that it provides to the host application through the OTT connection 1450.

The OTT connection 1450 may extend via a connection 1460 between the host 1402 and the network node 1404 and via a wireless connection 1470 between the network node 1404 and the UE 1406 to provide the connection between the host 1402 and the UE 1406. The connection 1460 and wireless connection 1470, over which the OTT connection 1450 may be provided, have been drawn abstractly to illustrate the communication between the host 1402 and the UE 1406 via the network node 1404, without explicit reference to any intermediary devices and the precise routing of messages via these devices.

As an example of transmitting data via the OTT connection 1450, in step 1408, the host 1402 provides user data, which may be performed by executing a host application. In some embodiments, the user data is associated with a particular human user interacting with the UE 1406. In other embodiments, the user data is associated with a UE 1406 that shares data with the host 1402 without explicit human interaction. In step 1410, the host 1402 initiates a transmission carrying the user data towards the UE 1406. The host 1402 may initiate the transmission responsive to a request transmitted by the UE 1406. The request may be caused by human interaction with the UE 1406 or by operation of the client application executing on the UE 1406. The transmission may pass via the network node 1404, in accordance with the teachings of the embodiments described throughout this disclosure. Accordingly, in step 1412, the network node 1404 transmits to the UE 1406 the user data that was carried in the transmission that the host 1402 initiated, in accordance with the teachings of the embodiments described throughout this disclosure. In step 1414, the UE 1406 receives the user data carried in the transmission, which may be performed by a client application executed on the UE 1406 associated with the host application executed by the host 1402.

In some examples, the UE 1406 executes a client application which provides user data to the host 1402. The user data may be provided in reaction or response to the data received from the host 1402. Accordingly, in step 1416, the UE 1406 may provide user data, which may be performed by executing the client application. In providing the user data, the client application may further consider user input received from the user via an input/output interface of the UE 1406. Regardless of the specific manner in which the user data was provided, the UE 1406 initiates, in step 1418, transmission of the user data towards the host 1402 via the network node 1404. In step 1420, in accordance with the teachings of the embodiments described throughout this disclosure, the network node 1404 receives user data from the UE 1406 and initiates transmission of the received user data towards the host 1402. In step 1422, the host 1402 receives the user data carried in the transmission initiated by the UE 1406.

One or more of the various embodiments improve the performance of OTT services provided to the UE 1406 using the OTT connection 1450, in which the wireless connection 1470 forms the last segment.

In an example scenario, factory status information may be collected and analyzed by the host 1402. As another example, the host 1402 may process audio and video data which may have been retrieved from a UE for use in creating maps. As another example, the host 1402 may collect and analyze real-time data to assist in controlling vehicle congestion (e.g., controlling traffic lights). As another example, the host 1402 may store surveillance video uploaded by a UE. As another example, the host 1402 may store or control access to media content such as video, audio, VR or AR which it can broadcast, multicast or unicast to UEs. As other examples, the host 1402 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1450 between the host 1402 and UE 1406, in response to variations in the measurement results. The measurement procedure and/or the network functionality for reconfiguring the OTT connection may be implemented in software and hardware of the host 1402 and/or UE 1406. In some embodiments, sensors (not shown) may be deployed in or in association with other devices through which the OTT connection 1450 passes; the sensors may participate in the measurement procedure by supplying values of the monitored quantities exemplified above, or supplying values of other physical quantities from which software may compute or estimate the monitored quantities. The reconfiguring of the OTT connection 1450 may include message format, retransmission settings, preferred routing etc.; the reconfiguring need not directly alter the operation of the network node 1404. Such procedures and functionalities may be known and practiced in the art. In certain embodiments, measurements may involve proprietary UE signaling that facilitates measurements of throughput, propagation times, latency and the like, by the host 1402. The measurements may be implemented in that software causes messages to be transmitted, in particular empty or ‘dummy’ messages, using the OTT connection 1450 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

Notably, modifications and other embodiments of the present disclosure will come to mind to one skilled in the art having the benefit of the teachings presented in the foregoing descriptions and the associated drawings. Therefore, it is to be understood that the present disclosure is not to be limited to the specific embodiments disclosed and that modifications and other embodiments are intended to be included within the scope of this disclosure. Although specific terms may be employed herein, they are used in a generic and descriptive sense only and not for purposes of limitation.

1.-30. (canceled)

31. A method performed by a wireless communication device configured for use in a wireless communication network, the method comprising:
generating a subscription concealed identifier that conceals a subscription identifier part of a subscription permanent identifier and conceals a set of one or more data fields which is agnostic as to a type of data that the set conveys; and
transmitting the subscription concealed identifier.

32. The method of claim 31, wherein the set of one or more data fields include:
a value field and a type field, wherein the value field conveys the data and the type field indicates a type of the data conveyed; and/or
a value field, a length field, and a type field, wherein the value field conveys the data, the type field indicates a type of the data conveyed, and the length field indicates a length of the value field or a length of the set of one or more fields.

33. The method of claim 31, wherein the set of one or more data fields conveys data describing communication, service, and/or network resources associated with a subscription identified by the subscription permanent identifier.

34. The method of claim 33, wherein the data describes:
a type and/or pattern of communication expected for the subscription; and/or
a mobility pattern expected for the subscription; and/or
a requirement and/or policy to be met for communication associated with the subscription.

35. The method of claim 33, wherein the data indicates
a Manufacturer Usage Description (MUD) file associated with the subscription; and/or
a network token associated with the subscription.

36. The method of claim 33, wherein the network resources associated with the subscription include a network slice and/or a mobile virtual network operator associated with the subscription.

37. The method of claim 31, wherein said generating comprises:
constructing a scheme input from the subscription identifier part and from the set of one or more data fields;
executing a protection scheme with the constructed scheme input as input, to obtain a scheme output; and
constructing the subscription concealed identifier with a data field that contains the scheme output.

38. The method of claim 31, wherein said transmitting comprises transmitting the subscription concealed identifier in a registration request or a service request to the communication network.

39. A method performed by a network node configured for use in a communication network, the method comprising:
receiving a subscription concealed identifier that conceals a subscription identifier part of a subscription permanent identifier and conceals a set of one or more data fields which is agnostic as to a type of data that the set conveys.

40. The method of claim 39, wherein the set of one or more data fields include:
a value field and a type field, wherein the value field conveys the data and the type field indicates a type of the data conveyed; and/or
a value field, a length field, and a type field, wherein the value field conveys the data, the type field indicates a type of the data conveyed, and the length field indicates a length of the value field or a length of the set of one or more fields.

41. The method of claim 39, wherein the set of one or more data fields conveys data describing communication, service, and/or network resources associated with a subscription identified by the subscription permanent identifier.

42. The method of claim 41, wherein the data describes:
a type and/or pattern of communication expected for the subscription; and/or
a mobility pattern expected for the subscription; and/or
a requirement and/or policy to be met for communication associated with the subscription.

43. The method of claim 41, wherein the data indicates
a Manufacturer Usage Description (MUD) file associated with the subscription; and/or
a network token associated with the subscription.

44. The method of claim 41, wherein the network resources associated with the subscription include a network slice and/or a mobile virtual network operator associated with the subscription.

45. The method of claim 41, further comprising, based on the conveyed data, configuring the communication network for use by the subscription.

46. The method of claim 45, wherein said configuring comprises one or more of:
allocating resources in the communication network for use by the subscription;
selecting and/or configuring network services for the subscription;
orchestrating, selecting, and/or configuring a network slice for use by the subscription;
configuring an access network for the subscription;
configuring a session for the subscription; or
allocating an address to for use by the subscription.

47. The method of claim 46, wherein said configuring comprises orchestrating, based on the data conveyed by the set, a network slice, for use by the subscription, that matches a type and/or pattern of communication expected for the subscription and/or that meets a requirement and/or policy to be met for communication associated with the subscription.

48. The method of claim 39, wherein said receiving comprises receiving the subscription concealed identifier in a registration request or a service request from a communication device.

49. A communication device configured for use in a communication network, the communication device comprising:
communication circuitry; and
processing circuitry configured to:
generate a subscription concealed identifier that conceals a subscription identifier part of a subscription permanent identifier and conceals a set of one or more data fields which is agnostic as to a type of data that the set conveys; and
transmit the subscription concealed identifier.

50. A network node configured for use in a communication network, the network node comprising:
communication circuitry; and
processing circuitry configured to receiving a subscription concealed identifier that conceals a subscription identifier part of a subscription permanent identifier and conceals a set of one or more data fields which is agnostic as to a type of data that the set conveys.
